(19) United States
(12) Patent Application Publication
(10) Pub. No.: US 2006/0060155 A1
(43) Pub. Date: Mar. 23, 2006

(54) Animal restraint for vets/pet owners

(76) Inventor: Tammy L. Ip, Albertson, NY (US)

Correspondence Address: LITMAN LAW OFFICES, LTD, PO BOX 15035, CRYSTAL CITY STATION, ARLINGTON, VA, 22215, US

(21) Appl. No.: 11/225,191

(22) Filed: Sep. 14, 2005

Related U.S. Application Data
(60) Provisional application No. 60/610,526, filed on Sep. 17, 2004.

(51) Int. Cl. A01K 13/00

(52) U.S. Cl. 119/850

(57) ABSTRACT

The animal restraint for vets/pet owners is frustoconical in shape and made of cloth or other flexible material. Both ends are left open. The opening for the head is of smaller diameter and has a drawstring with a cinch for closing the restraint around the neck of the animal. The opening for the tail end is of larger diameter and also has a drawstring or cord for closing the restraint around the tail or hind end of the animal. A centrally positioned drawstring has a cinch for closing the restraint around the torso of the animal between front and rear legs. The restraint is constructed of panels of material forming access slits having hook and loop fastening strips for closure of the access slits.

### CROSS-REFERENCE TO RELATED APPLICATION

This application claims the benefit of U.S. Provisional Patent Application Ser. No. 60/610,526, filed Sep. 17, 2004.

### BACKGROUND OF THE INVENTION

1. Field of the Invention

The present invention relates to animal restraints. More particularly, the present invention relates to an animal restraint for a pet, such as a cat, that is useful in carrying out such functions as providing veterinary care, grooming, and medicating the animal.

2. Description of the Related Art

The restraint of pets that have claws or nails when providing veterinary treatment or home care is often necessary to avoid injury to the handler and to immobilize the pet in order to allow treatment. It is common practice to wrap the animal tightly in a towel for these purposes. However, this method is far from ideal, as a struggling animal may escape, or access to certain parts of the animal may be hindered. Existing animal restraints fail either to adequately immobilize the animal or to provide necessary access to various parts of the animal for treatment. Easy introduction of the animal into the restraint is also a persistent problem in known designs. It would be desirable to provide an animal restraint for small pets that would have the characteristics of being easily applied, effective and safe in holding and restraining the animal, and that would allow access to necessary parts of the animal for treatment. It is also desirable for the animal restraint to be inexpensive to produce.

U.S. Pat. No. 4,137,870, issued Feb. 6, 1979 to Cano, describes a wrap-around animal restraint with a contoured, flexible enclosure for encasing the animal using a hook and loop (Velcro®) fastening system to join the edges. If there is a need for further restraint, tie strips spaced along the flexible enclosure can be wrapped around and tied so as to prevent the escape of the animal if any part of the flexible enclosure is opened for examination and treatment.

U.S. Pat. No. 5,109,801, issued May 5, 1992 to Gahagan, describes an animal restraint that holds the body while allowing the head to protrude through an adjustable tie-and-loop opening. Additional ties and loops are located along the body of the animal restraint. The recommended material for this restraint is mesh for ease in providing medications, such as injections.

U.S. Pat. No. 5,975,028, issued Nov. 2, 1999 to Wetmore, describes an elongated restraint for an animal, the restraint having a longitudinal sheet and multiple individually releasable fastened flaps that are shaped to be disposed over the animal's body, and that employs hook and loop material for fastening the flaps together over the body and head of the animal.

U.S. Pat. No. 6,394,039, issued May 28, 2002 to Grauer, describes a device comprised of a flexible enclosure for receiving a cat, the enclosure having respective openings for the neck and tail. The neck opening is adjustable by a drawstring. Another embodiment of this design features hook and loop material used to fasten panels that wrap around the cat.

U.S. Pat. No. 6,446,579, issued Sep. 10, 2002 to Griebling, describes an animal restraint consisting of a rigid, cylindrically shaped, hollow tube, which is open at both ends. The tube has a tab at one end and sits on a base.

International Patent No. WO 90/01910, published Mar. 8, 1990, discloses a cat restrainer having a supporting base member with four leg openings stretching over longitudinal plastic bars.

United Kingdom Patent No. 2,324,959, published Nov. 11, 1998, discloses an animal restraining device for restraining an animal in a car. The device has a flexible housing attached to a frame that is strapped to a car seat.

United Kingdom Patent No. 2,363,963, published Jan. 16, 2002, discloses a cat restraining device that is a bag-shaped enclosure with apertures for receiving the tail and head of the cat.

None of the above inventions and patents, taken either singly or in combination, is seen to describe the instant invention as claimed. Thus, an animal restraint for vets/pet owners solving the aforementioned problems is desired.

### SUMMARY OF THE INVENTION

The animal restraint for vets/pet owners is frustoconical in shape and made of cloth or other flexible material. Both ends of the restraint are left open. The opening for the head is of smaller diameter and has a drawstring or cord with a cinch for closing the restraint around the neck of the animal. The opening for the tail end is of larger diameter and also has a drawstring or cord for closing the restraint around the tail or hind end of the animal. A centrally positioned drawstring or cord has a cinch for closing the restraint around the torso of the animal between front and rear legs and divides the restraint into a front and a rear portion.

The restraint is constructed of panels of material. Each panel has opposing, longitudinally extending hems. The panels are held together by tie sleeves that receive the drawstrings at the front, rear and center of the restraint. When the panels are assembled, the hems of adjacent panels overlap to form open seams. Releasable fasteners, such as mating strips of hook and loop fastening material (Velcro), are disposed on the hems between the tie sleeves so that the seams form reclosable access slits that can be opened to provide access to specific locations on the body of the animal, and that can be closed when access is not needed or while handling the animal. Other means of closure, such as buttons, snaps, hooks, or zippers, may be substituted for the hook and loop fastening material.

It is a feature of the invention to provide improved elements and arrangements thereof for the purposes described which are inexpensive, dependable and fully effective in accomplishing its intended purposes.

These and other features of the present invention will become readily apparent upon further review of the following specification and drawings.

### BRIEF DESCRIPTION OF THE DRAWINGS

FIG. 1 is an environmental, perspective view of an animal restraint according to the present invention.

FIG. 2 is a perspective view of the animal restraint of the present invention in an open state.

FIG. 3 is a side elevation view of the animal restraint according to the present invention.

FIG. 4 is a plan view of the inner surface of the animal restraint of the present invention, the restraint being separated at the tie seam and spread flat.

Similar reference characters denote corresponding features consistently throughout the attached drawings.

### DETAILED DESCRIPTION OF THE PREFERRED EMBODIMENT

The present invention is an animal restraint that provides for immobilization of the animal between neck and tail or hind end, and that has closable access slits along its length for treatment of the animal. The restraint is particularly useful for cats, as it prevents motion and use of the cat's claws and legs.

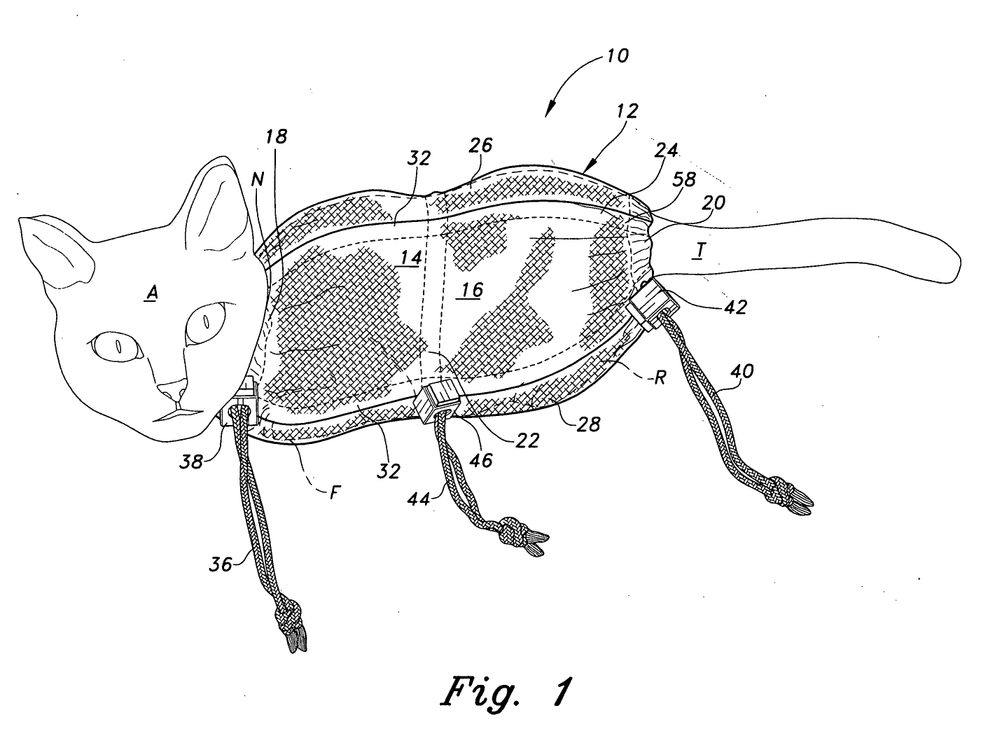

Referring to FIGS. 1-4, there is shown an animal restraint system that, in its entirety, is represented by the reference number 10. Animal restraint system 10 is a generally tubular, frustoconical sleeve 12 or shell of cloth or other flexible material. The sleeve 12 has a front portion 14 and a rear portion 16. The front portion has a front circumferential tie sleeve 18 defining the front end. The rear portion 16 has a tail circumferential tie sleeve 20 defining the rear end. A central circumferential tie sleeve 22 divides conical sleeve 12 into front portion 14 and rear portion 16.

As seen in FIG. 1, there is shown an animal A contained in the restrainer system 10, having front tie sleeve 18 tightened around the neck N, tail tie sleeve 20 tightened around the tail T, and central tie sleeve 22 tightened around the trunk of the animal A between front legs F and rear legs R, thus securely holding animal A in such a manner as to prevent the animal A from repositioning itself in tightened sleeve 12.

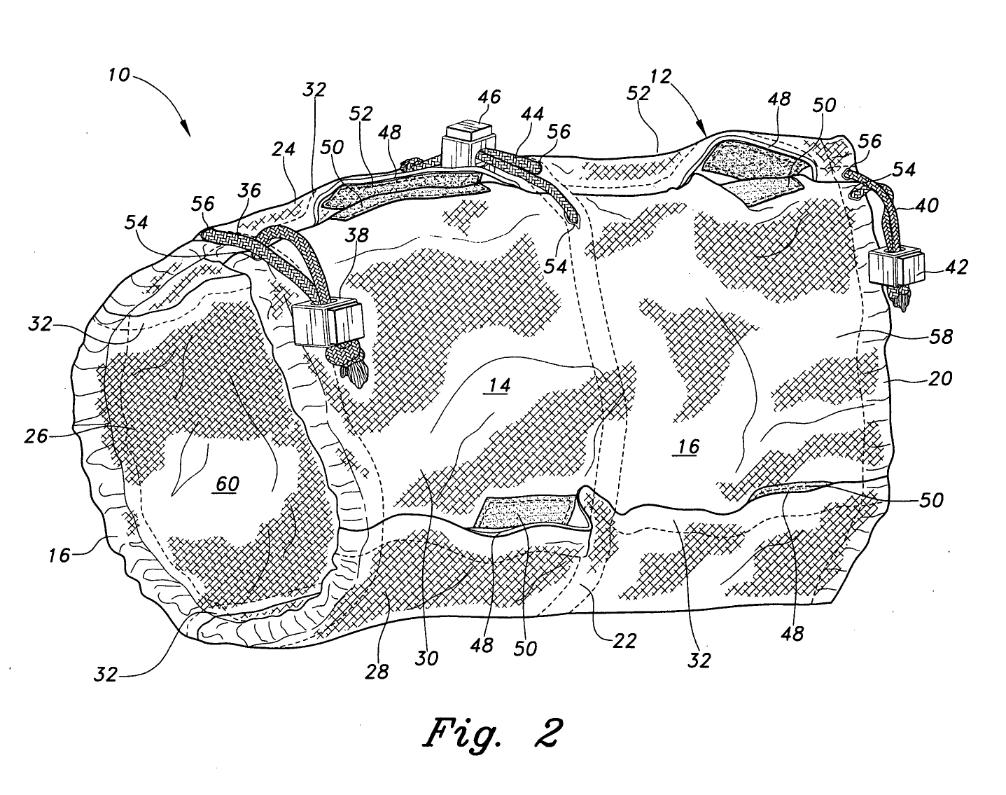

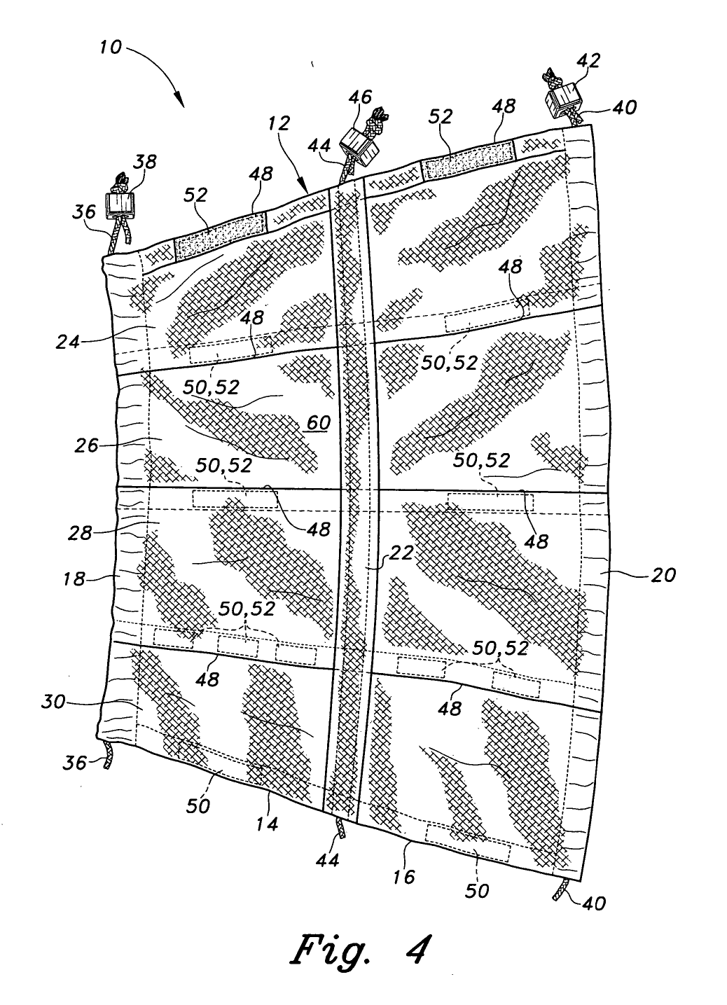

The sleeve 12 is made up of a first panel 24, a second panel 26, a third panel 28, and a fourth panel 30 (see FIG. 4), each panel having longitudinally extending hems 32 along opposing sides thereof. The assembly of panels forms the tubular flexible material sleeve 12 having outer surface 58 and inner surface 60 (see FIG. 2). The front end of each panel is hemmed and sewn together, forming the front circumferential tie sleeve 18. The rear end of each panel is hemmed and sewn together, forming the tail circumferential tie sleeve 20. A strip of cloth or the like is sewn to the inner side 60 of the sleeve, forming the central circumferential tie sleeve 22 and dividing the sleeve into the front portion 14 and rear portion 16, as described above. The sleeve 12 is described as being constructed with four panels. However, the sleeve 12 may be made of fewer than four panels or more than four panels, as desired.

Referring to FIG. 2, front tie cord 36 acts as a drawstring and extends from front circumferential tie sleeve 18 through a left tie cord outlet 54 and a right cord outlet 56 and is secured at any desired point therealong by front tie cinch 38. Tail tie cord 40 acts as a drawstring and extends from tail circumferential tie sleeve 20 through a left tie cord outlet 54 and a right cord outlet 56 and is secured at any desired point therealong by tail tie cinch 42. Central tie cord 44 acts as a drawstring and extends from central circumferential tie sleeve 22 through a left tie cord outlet 54 and a right cord 56 and is secured at any desired point therealong by central tie cinch 46. Tie cinches 38, 42, and 46 are of the push button release type, as shown. However, any appropriate tie cinch may be employed in the present invention.

Still referring to FIG. 2, longitudinally extending hems 32 of panels 24, 26, 28, and 30 form access slits 48 between the tie sleeves 18, 22, and 20, respectively. Slits 48 provide access to a particular location on the body of the animal for treatment by a veterinarian, such as for the administration of immunization injections. Slits 48 may be kept securely closed as desired by selectively openable and closable access means, such as mating hook and loop fastening material (Velcro) strips 50 and 52. During use of the animal restraint system 10, usually only one slit 48 is opened at a time, keeping the animal A secured at all times. Two or more slits 48 may be opened during treatment or grooming when appropriate, as desired. Other closure means may be substituted for the hook and loop fastening material, such as buttons, snaps, hooks, or zippers.

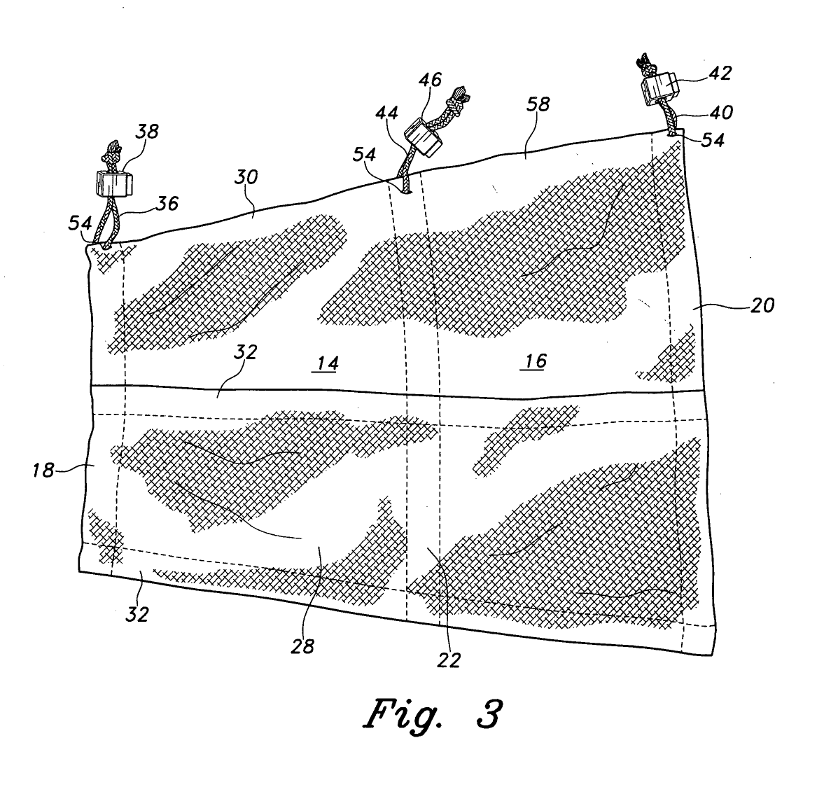

Referring to FIG. 3, there is shown a side elevation view of the restraining sleeve. Although the cinches 38, 42, and 46, are shown in FIG. 1 located along the lower portion of the animal A for illustration purposes, it is preferred that the animal be restrained so that cinches 38, 42, and 46 are located along the back of the animal in order to prevent the animal reaching the ties with its teeth.

Referring to FIG. 4, there is shown a plan view of the inner surface 60 of the present invention where the overlap of the hems of the panels is shown, along with the positions of hook and loop material strips 50 and 52 (shown in hidden lines) between the panel seams 32 (see FIG. 3). The cloth strip forming the central circumferential tie sleeve 22 is clearly shown.

Although the animal securing device of the present invention is shown as being frustoconical in construction to assist in catching the animal and correctly placing it in the securing device, other shapes, such as cylindrical, are contemplated by the invention and are considered within the scope thereof.

It is to be understood that the present invention is not limited to the embodiment described above, but encompasses any and all embodiments within the scope of the following claims.

I claim:

1. An animal restraint, comprising:
a generally tubular, flexible sleeve having a front end and a rear end, the sleeve having at least one access slit defined therein;
a front circumferential tie sleeve disposed around the front end of the tubular sleeve and a rear circumferential tie sleeve disposed around the rear end of the tubular sleeve;
a central circumferential tie sleeve disposed around the tubular sleeve between the front tie sleeve and the rear tie sleeve, the central tie sleeve dividing the tubular sleeve into a front portion and a rear portion;
corresponding tie cords extending through each of said circumferential tie sleeves, respectively, and acting as drawstrings therein, the front tie sleeve and tie cord being adapted for tightening around a restrained animal's neck, the tail tie sleeve and tie cord being adapted for tightening around the restrained animal's tail end, and the central tie sleeve and tie cord being adapted for tightening around the restrained animal's trunk between the animal's front legs and rear legs; and
at least one releasable fastener disposed on opposite sides of the access slit, whereby the restrained animal's limbs are confined within the tubular sleeve, the access slit being reclosable for access to a portion of the restrained animal's body.

2. The animal restraint according to claim 1, wherein said tubular sleeve is made from cloth fabric.

3. The animal restraint according to claim 1, wherein said tubular sleeve comprises a plurality of panels, each of the panels having a front end, a rear end, and longitudinally extending hems on opposing sides extending between the front end and the rear end.

4. The animal restraint according to claim 3, wherein the front ends of said panels are hemmed and jointed together to define the front tie sleeve and the front end of said tubular sleeve, the rear ends of said panels are hemmed and joined together to defined the rear tie sleeve and the rear end of said tubular sleeve, and said central tie sleeve joins said panels together centrally between the front end and the rear end of said tubular sleeve.

5. The animal restraint according to claim 4, wherein the hems of adjacent pairs of said panels define the at least one access slit, the at least one slit comprising a plurality of access slits defined in the front and rear portions of said tubular sleeve.

6. The animal restraint according to claim 1, wherein said releasable fastener comprises mating strips of hook and loop fastening material.

7. The animal restraint according to claim 1, wherein said releasable fastener is selected from the group consisting of hook and loop fastening material, buttons, snaps, hooks, and zippers.

8. The animal restraint according to claim 1, further comprising a plurality of cinches, each of said tie cords having one of the cinches disposed thereon.

9. The animal restraint according to claim 1, wherein said tubular sleeve is frustoconical in shape, said tubular sleeve defining a front opening and a rear opening larger in diameter than the front opening.

10. An animal restraint, comprising:
a generally tubular, flexible sleeve having a front end and a rear end, the sleeve having at least one access slit defined therein, the front end and the rear end defining front and rear openings, respectively, the rear opening being larger in diameter than the front opening;
a front circumferential tie sleeve disposed around the front end of the tubular sleeve and a rear circumferential tie sleeve disposed around the rear end of the tubular sleeve;
corresponding tie cords extending through each of said circumferential tie sleeves, respectively, and acting as drawstrings therein, the front tie sleeve and tie cord being adapted for tightening around a restrained animal's neck and the tail tie sleeve and tie cord being adapted for tightening around the restrained animal's tail end; and
at least one releasable fastener disposed on opposite sides of the access slit, whereby the restrained animal's limbs are confined within the tubular sleeve, the access slit being reclosable for access to a portion of the restrained animal's body.

11. The animal restraint according to claim 10, further comprising:
a central circumferential tie sleeve disposed around the tubular sleeve between the front tie sleeve and the rear tie sleeve, the central tie sleeve dividing the tubular sleeve into a front portion and a rear portion; and
a central tie cord extending through the central tie sleeve, the central tie sleeve and tie cord being adapted for tightening around the restrained animal's trunk between the animal's front legs and rear legs.

12. The animal restraint according to claim 11, wherein said tubular sleeve comprises a plurality of panels, each of the panels having a front end, a rear end, and longitudinally extending hems on opposing sides extending between the front end and the rear end.

13. The animal restraint according to claim 12, wherein the front ends of said panels are hemmed and jointed together to define the front tie sleeve and the front end of said tubular sleeve, the rear ends of said panels are hemmed and joined together to defined the rear tie sleeve and the rear end of said tubular sleeve, and said central tie sleeve joins said panels together centrally between the front end and the rear end of said tubular sleeve.

14. The animal restraint according to claim 13, wherein the hems of adjacent pairs of said panels define the at least one access slit, the at least one slit comprising a plurality of access slits defined in the front and rear portions of said tubular sleeve.

15. The animal restraint according to claim 10, wherein said releasable fastener comprises mating strips of hook and loop fastening material.

16. An animal restraint, comprising:
a generally tubular, flexible sleeve having a front end and a rear end, the sleeve having at least one access slit defined therein;
a front circumferential tie sleeve disposed around the front end of the tubular sleeve and a rear circumferential tie sleeve disposed around the rear end of the tubular sleeve;
a central circumferential tie sleeve disposed around the tubular sleeve between the front tie sleeve and the rear tie sleeve, the central tie sleeve dividing the tubular sleeve into a front portion and a rear portion;
corresponding tie cords extending through each of said circumferential tie sleeves, respectively, and acting as drawstrings therein, the front tie sleeve and tie cord being adapted for tightening around a restrained animal's neck, the tail tie sleeve and tie cord being adapted for tightening around the restrained animal's tail end, and the central tie sleeve and tie cord being adapted for tightening around the restrained animal's trunk between the animal's front legs and rear legs; and
means for releasably fastening the access slit, whereby the restrained animal's limbs are confined within the tubular sleeve, the access slit being reclosable for access to a portion of the restrained animal's body.

17. The animal restraint according to claim 16, wherein said fastening means comprises mating strips of hook and loop fastening material.
